(19) United States
(12) Patent Application Publication
(10) Pub. No.: US 2002/0080381 A1
(43) Pub. Date: Jun. 27, 2002

(54) Consumable management device, an image forming system, and a method of replenishing an imaging consumable

(76) Inventor: Robert E. Haines, Boise, ID (US)

Correspondence Address: HEWLETT-PACKARD COMPANY, Intellectual Property Administration, P.O.Box 272400, Fort Collins, CO, 80527-2400, US

(21) Appl. No.: 09/738,795

(22) Filed: Dec. 13, 2000

(51) Int. Cl. G06F 15/00

(52) U.S. Cl. 358/1.14

(57) ABSTRACT

A consumable management device, an image forming system, and a method of replenishing an imaging consumable are described. According to one aspect, a consumable management device includes an interface configured to receive a first message including a first designation identifying an imaging consumable used by an image forming device to form hard images; and processing circuitry coupled with the interface, the processing circuitry being configured to convert the first designation identifying the imaging consumable to a second designation identifying the imaging consumable, to generate a second message including the second designation, and to forward the second message to the interface for communication to an entity for assisting with replenishment of the imaging consumable.

### FIELD OF THE INVENTION

This invention pertains to a consumable management device, an image forming system, and a method of replenishing an imaging consumable.

### BACKGROUND OF THE INVENTION

Systems and methods relating to document generation have experienced advancements in both host device configurations, such as personal computers, and imaging devices, such as printers. Personal computers operate at faster processing rates with increased storage capacities while imaging devices provide tremendous resolution, color capabilities, and enhanced imaging speeds, for example.

Imaging devices configured to generate hard images use consumables during operation. Expiration of a consumable ceases operation of the corresponding imaging device until replacement of the same.

In some imaging system arrangements, such as network based arrangements comprising numerous imaging devices, a person is assigned with monitoring consumable usage, reordering consumables, etc. to maintain operability of the imaging devices. Such entails the individual manually verifying the amount of consumables remaining within inventory, manually monitoring status of consumables of the respective devices and replenishment of the consumables in inventory and within individual imaging devices when necessary. In systems having perhaps hundreds of imaging devices, the task of monitoring, replacing and maintaining consumables for such imaging devices is increasingly time consuming and subject to misordering of consumables and other errors.

Some conventional arrangements utilizing image forming devices have existing communication arrangements, such as customer order systems, with consumable suppliers. A person manually inputs information into a system to compile the needed consumables and the system interfaces with the supplier to fulfill the order. These conventional systems are also subject to errors in manual data entry, necessary consumables being left out from an order all together, and other similar drawbacks.

Accordingly, there exists a need to provide improved devices and methodologies to assist with management and replenishment of imaging consumables.

### SUMMARY OF THE INVENTION

The invention provides a consumable management device, an imaging forming system, and a method of replenishing an imaging consumable.

According to one aspect, a consumable management device comprises: an interface configured to receive a first message including a first designation identifying an imaging consumable used by an image forming device to form hard images; and processing circuitry coupled with the interface, the processing circuitry being configured to convert the first designation identifying the imaging consumable to a second designation identifying the imaging consumable, to generate a second message including the second designation, and to forward the second message to the interface for communication to an entity for assisting with replenishment of the imaging consumable.

According to another aspect, an image forming system comprises: an image forming device configured to use an imaging consumable to form hard images, to monitor the status of the imaging consumable, and to generate a first message including a first designation identifying the imaging consumable responsive to the monitoring; and a consumable management device coupled with the image forming device and configured to receive the first message, to convert the first designation identifying the imaging consumable to a second designation identifying the imaging consumable, and to communicate a second message including the second designation to an entity for assisting with replenishment of the imaging consumable.

Yet another aspect of the invention provides a method of replenishing an imaging consumable usable to form hard images, the method comprising: receiving a first message including a first designation identifying the imaging consumable; converting the first designation to a second designation different than the first designation, the second designation identifying the imaging consumable; generating a second message including the second designation; and communicating the second message including the second designation to an entity for assisting with replenishment of the imaging consumable. Other aspects of the invention are disclosed herein.

Other features and advantages of the invention will become apparent to those of ordinary skill in the art upon review of the following detailed description, claims, and drawings.

### DESCRIPTION OF THE DRAWINGS

FIG. 1 is an isometric view of an exemplary image forming device.

FIG. 2 is a functional block diagram depicting an exemplary image forming system.

FIG. 3 is a functional block diagram depicting components of an exemplary image forming device.

FIG. 4 is a functional block diagram depicting components of an exemplary consumable management device.

FIG. 5 is a flow chart depicting an exemplary methodology executable within the consumable management device.

### DETAILED DESCRIPTION OF PREFERRED EMBODIMENTS

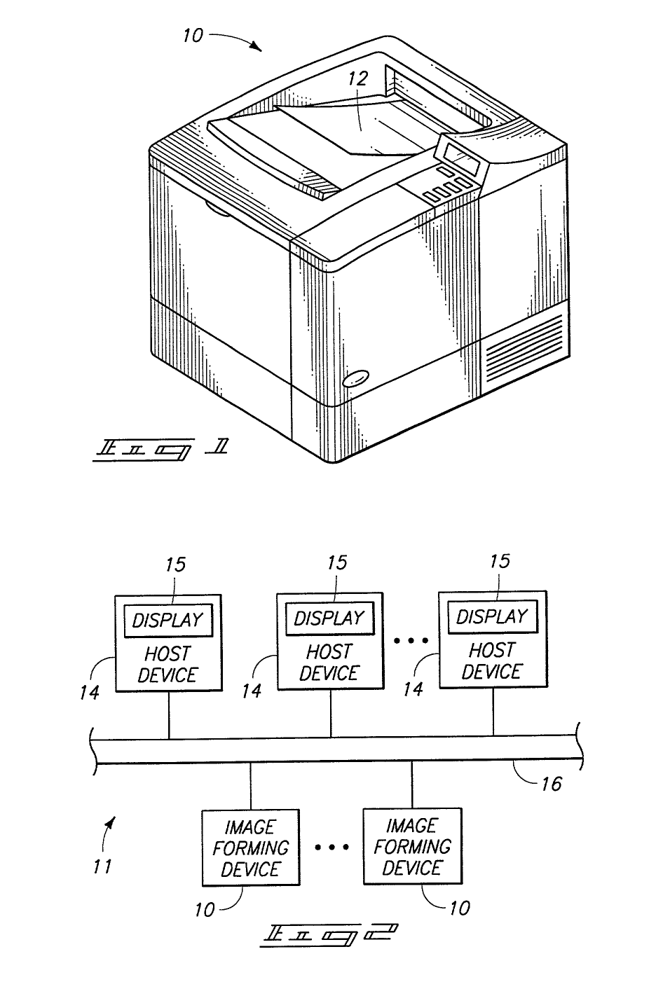

FIG. 1 depicts an exemplary image forming device 10. Image forming device 10 is configured to form hard images upon media 12 in the described embodiment. One exemplary image forming device 10 comprises a printer, such as a laser printer, ink jet printer, a dot matrix printer, or a dry medium printer. The present invention is embodied within other image forming device configurations such as multiple function peripheral devices, copiers, facsimile machines, plotters, etc. or other arrangements configured to form hard images upon media 12 according to alternative embodiments of the invention. Device 10 is arranged to form hard images upon media 12 including, for example, paper, envelopes, transparencies, labels, etc.

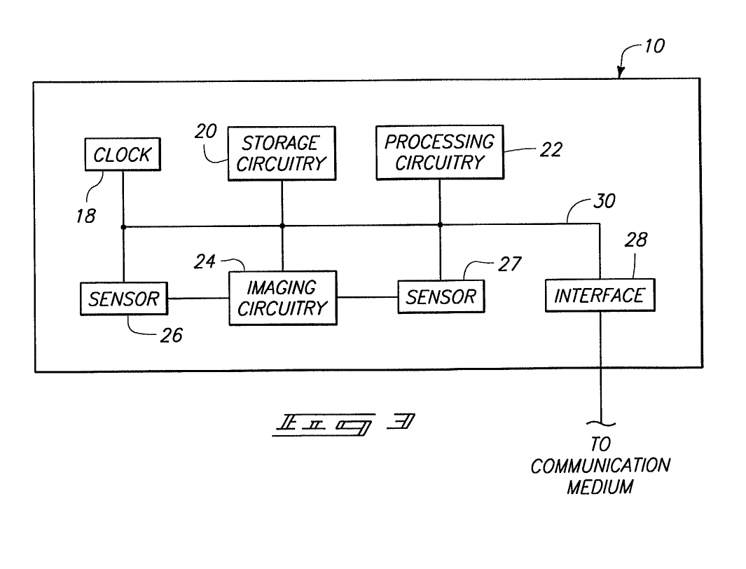

Referring to FIG. 2, an image forming system 11 is depicted comprising plural image forming devices 10, plural host devices 14 and a communication medium 16. Communication medium 16 provides connectivity intermediate image forming devices 10 and host devices 14 to implement communications therebetween. An exemplary communication medium 16 includes packet switched networks such as an Intranet network (e.g., Ethernet arrangement), Internet and/or other communication configurations operable to provide electronic exchange of information between image forming devices 10 and host devices 14, using an appropriate protocol, such as TCP/IP. Some of depicted devices 10, 14 of system 11 may be coupled with an Intranet portion of medium 16 while other devices 10, 14 are coupled with an Internet portion of medium 16. Other image forming systems 11 of the invention include more or less devices 10, 14 depending upon a given configuration or application. Further, other arrangements of communication medium 16 and other protocols for implementing communications intermediate devices 10, 14, are possible.

In general, host devices 14 are implemented as personal computers (PCs), servers, Web servers, or other devices configured to communicate with image forming devices 10. Host devices 14 individually include a display 15, such as a CRT or flat panel monitor, to display information to a user.

At least some host devices 14 execute applications wherein formation of hard images upon media is desired. Such may be referred to as user host devices 14. For example, host devices 14 comprising personal computers in one exemplary configuration execute an appropriate word processor, spread sheet, or other application capable of generating hard images, such as images upon appropriate media. Individual host devices 14 communicate image data via communication medium 16 to an appropriate image forming device 10 for hard imaging. Alternatively, image data to be printed or otherwise imaged using image forming devices 10 is supplied from other external devices (not shown) coupled with, for example, communication medium 16.

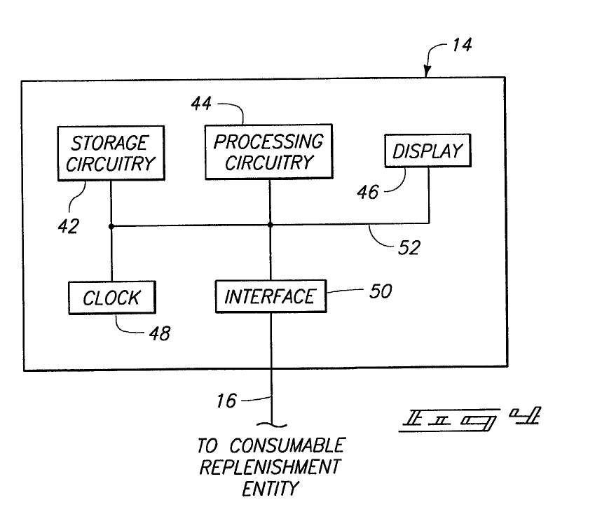

Referring to FIG. 3, exemplary components of a single image forming device 10 are shown. As illustrated, the depicted image forming device 10 includes a clock 18, storage circuitry 20, processing circuitry 22, imaging circuitry 24, a sensor 26, a sensor 27, and an interface 28 individually coupled with a communication medium 30. Communication medium 30 is configured as an internal bus to implement communication functionality intermediate components of device 10. Other configurations of image forming device 10 are provided in alternative arrangements (not shown).

Clock 18 is arranged to provide information regarding current moments in time. For example, clock 18 provides year, month, day and/or time information. In the depicted configuration, clock 18 is programmed upon installation within system 11. Updated timing information to verify the accuracy of clock 18 or to control timing within device 10 may be received from a timing source (not shown) external of image forming device 10.

Storage circuitry 20 is configured to store instructions for controlling various operations of image forming device 10 and other information or data as described in further detail below. Exemplary storage circuitry 20 comprises non-volatile memory (e.g., EEPROM, flash memory and/or read only memory (ROM)), random access memory (RAM), and hard disk and associated drive circuitry. Storage circuitry 20 is configured to store executable instructions as firmware or software configured to control operations of image forming device 10. Further, storage circuitry 20 stores image data used for the formation of hard images and any other appropriate information to be stored within image forming device 10.

Processing circuitry 22 is implemented as a dedicated microprocessor in the depicted embodiment of image forming device 10. Other arrangements of processing circuitry 22 are possible. Processing circuitry 22 is configured to execute a plurality of ordered executable instructions implemented as firmware and/or software. The ordered instructions are executed to control image forming operations within image forming device 10, to provide monitoring of components of device 10, to provide monitoring of imaging consumables used during imaging operations, and other operations of device 10.

Imaging circuitry 24 is configured to form hard images upon media 12 responsive to image data provided, for example, by a user host device 14. In the described printer embodiment, imaging circuitry 24 includes print circuitry arranged to print images upon media 12. In the exemplary described embodiment, imaging circuitry 24 includes paper path components (not shown) to implement movement of media 12 within image forming device 10, developing components (not shown) configured to provide a developing material, such as toner, upon media 12, fusing components (not shown) configured to affix the developing material to media 12 as well as any other components (not shown) to implement other desired processing or imaging operations, such as downstream processing of media (e.g., stapling, collating, etc).

Sensors 26, 27 are provided in the disclosed embodiment to monitor operations within imaging circuitry 24 of image forming device 10. Imaging circuitry 24 consumes imaging consumables during the formation of hard images. Exemplary imaging consumables include developing material, media, staples, and components having a fixed life span (e.g., fusing assembly and/or developing assembly). Plural sensors 26, 27 are provided to monitor plural imaging consumables, such as developing material and media, according to some aspects of the invention. More or less sensors are provided in other configurations of image forming device 10. Further, other imaging consumables may also be monitored depending upon the configuration of image forming device 10.

In the described embodiment, sensors 26, 27 are arranged to monitor respective statuses of plural imaging consumables. Status of an imaging consumable may be represented in a plurality of ways. For example, sensors 26, 27 are arranged in one embodiment to monitor remaining capacities of respective imaging consumables (e.g., amount of toner in weight or volume remaining for usage, amount of fuser life in hours remaining for usage). Alternatively, sensors 26, 27 are configured to monitor usage of the respective imaging consumables. Sensors 26, 27 may be additionally configured to indicate both remaining capacity and usage of respective consumables. The remaining capacity and/or usage information may be indicated in terms of weight, volume, hours, or any other unit capable of indicating usage or remaining capacity of the respective imaging consumables.

Sensors 26, 27 are configured to output respective signals indicative of the statuses (e.g., usage and/or remaining life) of imaging consumables to communication medium 30. Processing circuitry 22 is configured to receive and process the respective signals from medium 30.

Interface 28 is configured to implement connectivity of image forming device 10 to external components via an appropriate communication medium, for example. An exemplary interface 28 comprises a network interface card (NIC), such as a JetDirect(™) card, available from Hewlett-Packard Company. In the illustrated embodiment, interface 28 is coupled with communication medium 16. Image data, status information and any other desired data is received within and outputted from image forming device 10 using interface 28 in the described implementation.

Image forming devices 10 are individually operable to implement various functions regarding usage of imaging consumables during imaging and other operations, and replenishing of such imaging consumables. Image forming devices 10 assist a user (e.g., purchaser, maintainer) with replenishment of imaging consumables responsive to signals received from sensors 26, 27. Image forming devices 10 are operable to output an indication of the statuses of respective imaging consumables externally of device 10 using interface 28.

More specifically, and in one exemplary configuration, processing circuitry 22 receives the generated signals regarding statuses of imaging consumables from respective sensors 26, 27. Processing circuitry 22 formulates messages which are forwarded externally of device 10 to appropriate recipients for facilitating reordering of imaging consumables. As described below, exemplary messages generated by processing circuitry 22 include status messages identifying the imaging consumable, identifying the communicating device 10, and/or the status of the imaging consumable. As used herein, messages outputted from devices 10 are referred to as first messages.

According to the described embodiment, following an indication from sensors 26, 27 of one or more imaging consumable being at a predetermined status (e.g., low remaining capacity), processing circuitry 22 formulates an appropriate first message for application to one or more host device 14 as identified by an identifier stored within storage circuitry 20. In the depicted embodiment, processing circuitry 22 configures first messages as e-mail messages, files, requests, commands, etc. for communication using communication medium 16. Other formats of messages are possible.

In the described configuration, an e-mail address, uniform resource locator (URL) or other identifier of such host device 14 is provided within storage circuitry 20 of respective image forming devices 10 to direct communications of first messages. The identifier provided within image forming device 10 directs communications of first messages to an appropriate recipient, such as a purchaser, and/or consumable management device as described further below.

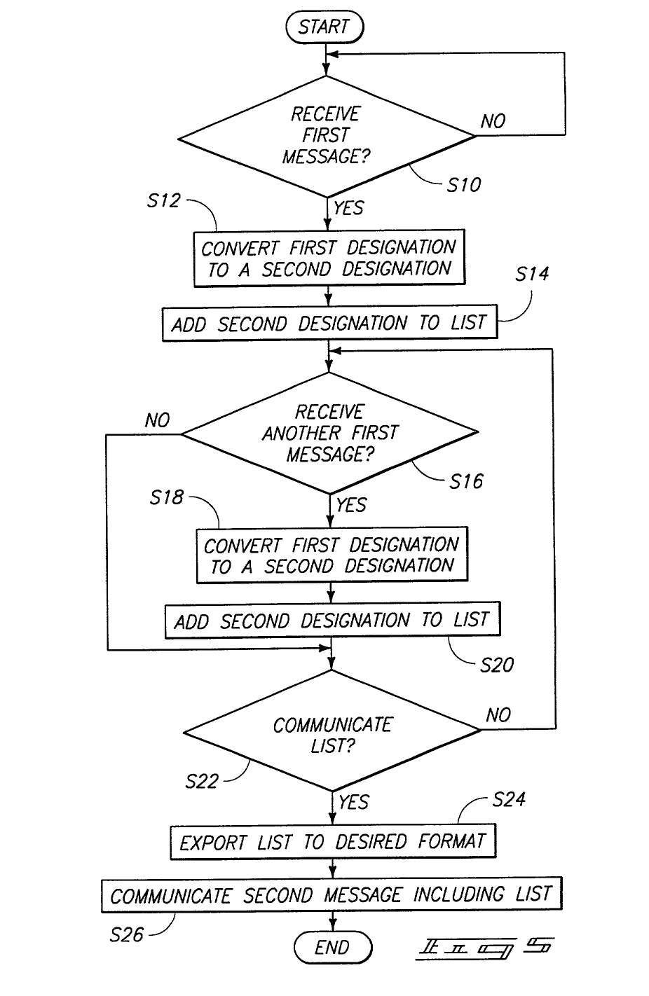

Referring to FIG. 4, an exemplary host device 14 configured to receive first messages is depicted. In one implementation, the recipient of first messages is a host device 14 of system 11 referred to as a consumable management device or consumable management host device 14. Consumable management host device 14 assists with replenishment of imaging consumables.

In one arrangement, consumable management host device 14 is associated with a purchaser of imaging consumables for respective ones of image forming devices 10. The consumable management host device 14 implemented according to this embodiment is a personal computer configured to receive the first messages.

In another arrangement, the consumable management host device 14 is implemented as a server configured to receive the first messages. In this arrangement, another host device 14 may be associated with an individual such as a purchaser or maintainer for assisting with replenishment of imaging consumables within image forming devices 10. Such is referred to as a purchaser device in this embodiment and may be implemented as a personal computer. First messages are forwarded either directly to consumable management host device 14, or to the purchaser device and subsequently to the appropriate consumable management host device 14. The purchaser device interfaces with the consumable management device 14 according to aspects of the invention.

The exemplary depicted consumable management host device 14 includes storage circuitry 42, processing circuitry 44, a display 46, a clock 48, and an interface 50 individually coupled with a communication medium 52. Communication medium 52 is configured as an internal bus to implement communication functionality intermediate components of device 14. Other configurations of consumable management host device 10 are provided in alternative arrangements (not shown).

As described hereafter, exemplary aspects of consumable management host device 14 are disclosed regarding monitoring statuses of imaging consumables within respective devices 10 and generating, if appropriate, messages for replenishment of imaging consumables. Consumable management host device 14 is arranged to output messages for facilitating replenishment of appropriate imaging consumables. Messages outputted from consumable management host device 14 are referred to as second messages herein.

Exemplary messages outputted from consumable management host device 14 are provided to a consumable replenishment entity configured to assist with replenishment of consumables. An exemplary consumable replenishment entity comprises an ordering system in existence for placing purchase orders to resellers or suppliers of the imaging consumables. For example, an entity comprises in one arrangement an automated purchase order system of a corporation wherein image forming system 11 is implemented. Such an entity includes a device such as a Web server, personal computer, etc. to communicate via communication medium 16 with image forming system 11 and consumable management host device 14, and receive messages therefrom. Other arrangements are possible and entity herein corresponds to my device, system or facility to assist with replenishment of consumables which uses identifiers or designations of imaging consumables different than the identifiers or designations used within image forming system 11.

Once an image forming device 10 generates an appropriate first message regarding an imaging consumable, it is forwarded to consumable management host device 14 (e.g., directly or via purchaser host device 14) according to aspects of the present invention. In one arrangement, consumable management host device 14 adds the indicated imaging consumable from the first message to a list used to formulate one or more second message for application to the entity capable of replenishing imaging consumables. Alternatively, the imaging consumables indicated in the first message are communicated separately from consumable management device 14 to the entity.

Storage circuitry 42 stores information regarding consumables responsive to received first messages. Exemplary storage circuitry 42 comprises non-volatile memory (e.g., EEPROM, flash memory and/or read only memory (ROM)), random access memory (RAM), and hard disk and associated drive circuitry. In addition, storage circuitry 42 stores executable instructions as firmware or software configured to control operations of consumable management device 40. Further, storage circuitry 42 is also configured to store information regarding imaging consumables of image forming devices 10 coupled therewith. In one configuration, storage circuitry 42 includes a database identifying the imaging consumables associated with devices 10. Storage circuitry 42 also includes a plurality of designations corresponding to the imaging consumables as described in further detail below. Storage circuitry 42 also stores an identifier of the entity for communicating messages thereto. Exemplary identifiers include an e-mail address or URL of an appropriate receiving device within or comprising the entity.

Clock 48 is configured to provide current timing information, such as, year, month, day and time information in the described embodiment.

Interface 50 coupled with communication medium 16 is configured to receive first messages concerning status of imaging consumables of respective image forming devices 10 and communicate second messages externally of device 14. An exemplary interface 50 comprises a JetDirect card.

Processing circuitry 44 comprises a dedicated microprocessor in the depicted exemplary configuration. Processing circuitry 44 controls operations of consumable management device 14 including processing of first messages regarding imaging consumables received within consumable management device 14 and formulation of one or more second message responsive thereto.

Exemplary first messages received within consumable management device 14 include a first designation identifying an imaging consumable used by the image forming device 10 to form hard images. The first designation is, in one example, a manufacturer part number for the imaging consumable requiring replenishment. For example, if an image forming device 10 comprising a printer runs low on toner, the first message includes a first designation comprising a manufacturer part number identifying the appropriate toner.

According to aspects of the present invention, processing circuitry 44 is configured to convert the first designation identifying the imaging consumable to a second designation identifying the imaging consumable. According to one described example, an exemplary second designation is a customer part number for the respective imaging consumable.

In an arrangement wherein image forming system 11 is provided within customer premises, the first designation may correspond to the manufacturer of components or devices within image forming system 11 and the second designation corresponds to identifiers used within an existing order system (or equivalent entity) used by the given customer owning the application or installed image forming system 11. The described first and second designations are exemplary and designations corresponding to other identifiers of imaging consumables are possible.

In one configuration, storage circuitry 42 is arranged to store a look-up table. The stored look-up table is typically tailored to the given application of image forming system 11 (and the components within image forming system 11) and the entity. The look-up table correlates first designations for given imaging consumables to second designations for the same respective imaging consumables. In the described example, the look-up table correlates manufacturer part numbers for the imaging consumables to customer part numbers for the respective imaging consumables. As previously stated, other designations of imaging consumables, and conversions thereof, are possible.

Processing circuitry 44 is configured to access the look-up table within storage circuitry 42 to convert first designations for imaging consumables to second designations according to aspects of the present invention. Alternative operations are possible to implement conversion of first designations of the imaging consumables to the desired second designations. Further, the look-up table or other conversion operator may be modified or replaced by processing circuitry 44 to accommodate flexibility within image forming system 11 to include new imaging consumables and delete out of date imaging consumables no longer used in image forming system 11.

According to one embodiment, for example wherein consumable management host device 14 is implemented as a personal computer, processing circuitry 44 operates to generate the second messages including one or more second designation corresponding to the received first message including one or more first designation. Processing circuitry 44 receives single first messages, converts the first designations therein to the appropriate second designation(s), and forwards a second message including the second designation(s) to interface 50 for communication to the appropriate entity responsible for assisting with replenishment of the imaging consumable. Such responsible entity recognizes the second designation(s) and thereafter facilitates ordering or supply of the identified imaging consumable(s) to the appropriate image forming device(s) 10, as identified within the second message according to one embodiment of the present invention.

According to another embodiment, for example wherein consumable management host device 14 comprises a server, processing circuitry 44 is configured to compile a list of depleted imaging consumables within storage circuitry 42. For example, processing circuitry 44 converts first designation(s) received within proper first messages to appropriate respective second designation(s) and stores the second designation(s) within storage circuitry 42. Processing circuitry 44 generates a list within storage circuitry 42 including the second designations. Thereafter, processing circuitry 44 generates the second message including the list comprising the second designations. Second messages including the described lists or single second designations comprise purchase orders in an exemplary arrangement.

In one implementation, first messages generated by host devices 10 are forwarded to a respective host device 14, comprising a personal computer associated, for example, with a purchaser or maintainer. Upon receipt within the purchaser or maintainer host device 14, an individual reviews the first messages and forwards the first messages to the consumable management host device 14. In accordance with one possible implementation of the presently described arrangement, the first messages are e-mail messages which individually include a hotlink to a Web site supported by the consumable management host device 14. The purchaser clicks upon the hotlink to thereafter forward the first message including the first designation to the consumable management host device 14, within an email, or other appropriate message. A hot-link comprises a URL or address that defines a route to consumable management host device 14.

Processing circuitry 44 is configured to formulate or generate second messages and communicate second messages according to predetermined conditions in exemplary aspects of the present invention. For example, in one embodiment, processing circuitry 44 monitors clock 48 and generates and communicates second messages individually including a single second designation or a list comprising one or more second designation at a predetermined moment in time (e.g., 8:00 am at the first of the month).

Alternatively, processing circuitry 44 is arranged to analyze the status of the identified imaging consumables within the first message(s) and to generate and communicate the second message(s) responsive to a predetermined status of one or more imaging consumable. For example, if a quantity of a given imaging consumable is indicated at a predetermined status, such can trigger processing circuitry 44 to generate and communicate the second messages. Other conditions may be utilized to cause processing circuitry 44 to generate and communicate the second messages. According to aspects of the present invention, the desired conditions are arranged to minimize the chances that an imaging consumable is depleted before replenishment of the same imaging consumable within image forming devices 10.

According to additional aspects of the invention, processing circuitry 44 is configured to generate second messages comprising quantity information corresponding to the imaging consumable(s) identified by the second designation(s). For example, a list including the second designations may include quantity information associated with individual second designations. Such occurs for example, if more than one image forming device 10 indicates a low status for the same imaging consumable.

Second messages can also include identification information such as a delivery address or attention information (with respect to a purchaser) corresponding to respective second designations therein. Such identification information is utilized to assure proper delivery of imaging consumables to the identified device 10, person, or address within system 11.

Communication medium 16 is configured to implement communications in a plurality of formats. Processing circuitry 44 is arranged in one embodiment to provide the second message in an appropriate format corresponding to the entity responsible for replenishment of the consumable. For example, in one embodiment, processing circuitry 44 generates the second message comprising an e-mail message and includes the second designation or the list of second designations as an attachment of the e-mail.

Processing circuitry 44 is arranged in one configuration to export the second designation(s) into one of a plurality of formats within the attachment. For example, in one arrangement, individual second designations or a list including plural second designations is exported into an eXtensible Markup Language (XML) format as an attachment of an e-mail for communication using communication medium 16. In the described arrangement, the chosen interface format corresponds to the format of the entity responsible for replenishment of consumables and can comprise a standard format such as SAP, or other B2B format. Such description of communications intermediate consumable management host device 14 of system 11 and the entity is exemplary and other communication methodologies or techniques are possible

According to some aspects, the existing customer order system or other entity is operable to send a notification after placing an order with a reseller or suppler providing confirmation of the placement of the order and information regarding a projected delivery date.

Referring to FIG. 5, an exemplary methodology for implementing above-described aspects of the present invention regarding generation and communication of a list to a customer ordering system or other entity is shown. The depicted methodology is implemented as a series of ordered executable instructions stored within storage circuitry 42 which are presented to processing circuitry 44 for execution. In other alternative configurations, the depicted methodology is implemented in hardware. The methodology of FIG. 5 depicts a plurality of aspects of the present invention. Individual ones of the depicted aspects are implemented in separate respective executable methodologies (not shown) in other arrangements of the present invention.

According to the depicted methodology, processing circuitry 44 initially proceeds to a step S10 to determine whether a first message has been received from an appropriate image forming device 10. Processing circuitry 44 idles at step S10 until a first message is received.

At a step S12, processing circuitry 44 converts a first designation of the imaging consumable within the received first message to a second designation identifying the same imaging consumable.

At a step S14, processing circuitry 44 adds the second designation to a list provided within storage circuitry 42.

At a step S16, processing circuitry 44 determines whether another first message has been received. If not, processing circuitry 44 proceeds to a step S22.

Otherwise, at a step S18, processing circuitry 44 converts the first designation identifying the same imaging consumable within another first message to a second designation identifying the same imaging consumable.

At a step S20, processing circuitry 44 adds the second designation to the list stored within storage circuitry 42.

At step S22, processing circuitry determines whether communication of the list is appropriate. The list is communicated at predetermined moments of time, responsive to status of one or more imaging consumable upon the list, or other criteria. If communication of the list is not appropriate, processing circuitry 44 returns to step S16.

Otherwise, processing circuitry 44 proceeds to a step S24 to export the list to a desired format corresponding to the customer order system or other entity responsible to assist with replenishment of consumables.

At a step S26, processing circuitry 44 generates a second message including the list and forwards the second message to interface 50 for communication to the consumable replenishment entity.

The protection sought is not to be limited to the disclosed embodiments, which are given by way of example only, but instead is to be limited only by the scope of the appended claims.

What is claimed is:

1. A consumable management device comprising:
an interface configured to receive a first message including a first designation identifying an imaging consumable used by an image forming device to form hard images; and
processing circuitry coupled with the interface, the processing circuitry being configured to convert the first designation identifying the imaging consumable to a second designation identifying the imaging consumable, to generate a second message including the second designation, and to forward the second message to the interface for communication to an entity for assisting with replenishment of the imaging consumable.

2. The device in accordance with claim 1 wherein the interface is configured to receive another first message including another first designation identifying another imaging consumable, and the processing circuitry is configured to convert the another first designation into another second designation identifying the another imaging consumable, and to generate the second message comprising a list including the second designations.

3. The device in accordance with claim 1 wherein the processing circuitry is configured to generate the second message comprising a quantity corresponding to the imaging consumable identified by the second designation.

4. The device in accordance with claim 1 wherein the processing circuitry is configured to generate the second message comprising an email message and to include the second designation as an attachment of the email.

5. The device in accordance with claim 1 wherein the processing circuitry is configured to convert the first designation comprising a manufacturer part number for the imaging consumable to the second designation comprising a customer part number for the imaging consumable.

6. The device in accordance with claim 1 further comprising storage circuitry configured to store a look-up table, and the processing circuitry is configured to access the look-up table to convert the first designation to the second designation.

7. The device in accordance with claim 1 wherein the processing circuitry is configured to export the second designations into one of a plurality of formats corresponding to the entity to generate the second message.

8. The device in accordance with claim 1 wherein the processing circuitry is configured to communicate the second message at a predetermined moment in time.

9. An image forming system comprising:
an image forming device configured to use an imaging consumable to form hard images, to monitor the status of the imaging consumable, and to generate a first message including a first designation identifying the imaging consumable responsive to the monitoring; and
a consumable management device coupled with the image forming device and configured to receive the first message, to convert the first designation identifying the imaging consumable to a second designation identifying the imaging consumable, and to communicate a second message including the second designation to an entity for assisting with replenishment of the imaging consumable.

10. The system in accordance with claim 9 wherein the consumable management device is configured to receive another first message including another first designation identifying another imaging consumable, to convert the another first designation into another second designation identifying the another imaging consumable, and to generate the second message comprising a list including the second designations.

11. The system in accordance with claim 9 wherein the consumable management device is configured to generate the second message comprising an email message and to include the second designation as an attachment of the email.

12. The system in accordance with claim 9 wherein the consumable management device is configured to covert the first designation comprising a manufacturer part number for the imaging consumable to the second designation comprising a customer part number for the imaging consumable.

13. The system in accordance with claim 9 wherein the image forming device comprises a printer.

14. A method of replenishing an imaging consumable usable to form hard images, the method comprising:
receiving a first message including a first designation identifying the imaging consumable;
converting the first designation to a second designation different than the first designation, the second designation identifying the imaging consumable;
generating a second message including the second designation; and
communicating the second message including the second designation to an entity for assisting with replenishment of the imaging consumable.

15. The method in accordance with claim 14 wherein the generating comprises generating the second message comprising a list including a plurality of different second designations identifying a plurality of different respective imaging consumables.

16. The method in accordance with claim 14 wherein the generating comprises generating the second message including a quantity corresponding to the imaging consumable identified by the second designation.

17. The method in accordance with claim 14 wherein the generating comprises:
generating the second message comprising an email message; and
providing the second designation as an attachment of the email message.

18. The method in accordance with claim 14 wherein the converting comprises converting the first designation comprising a manufacturer part number for the imaging consumable to the second designation comprising a customer part number for the imaging consumable.

19. The method in accordance with claim 14 wherein the generating comprises exporting the second designation into one of a plurality of formats corresponding to the entity.

20. The method in accordance with claim 14 wherein the communicating comprises communicating at a predetermined moment in time.
